(19) United States
(12) Patent Application Publication
(10) Pub. No.: US 2010/0150472 A1
(43) Pub. Date: Jun. 17, 2010

(54) METHOD FOR COMPOSING CONFOCAL MICROSCOPY IMAGE WITH HIGHER RESOLUTION

(75) Inventor: Yung-Chang Chen, Hsinchu (TW)

Correspondence Address: ROGER H. CHU, 19499 ERIC DRIVE, SARATOGA, CA, 95070, US

(73) Assignee: NATIONAL TSING HUA UNIVERSITY (TAIWAN), Hsinchu (TW)

(21) Appl. No.: 12/334,808

(22) Filed: Dec. 15, 2008

(51) Int. Cl. G06K 9/64

(52) U.S. Cl. 382/278

(57) ABSTRACT

A method for composing a confocal microscopy image with a higher resolution comprising the steps of: (1) start; (2) to decide whether the number of images to be stitched are more than two, if no, going to step (3), otherwise, going to step (7); (3) proceeding pyramidal correlations; (4) gaining compensation for the overlapped region of the two images; (5) proceeding an intensity adjustment beyond the overlapped regions; (6) proceeding a dynamic programming, then going to step (15); (7) to decide whether the pyramidal correlation is a must, if yes, going step (8), otherwise, going to step (12); (8) proceeding the pyramidal correlations; (9) proceeding an adjacency adjustment; (10) to decide whether a linear adjustment by a distance map is a must, if yes, going to step (11), otherwise, going to step (13); (11) proceeding the linear adjustment by the distance map; (12) proceeding an scale invariant feature transform (SIFT); (13) gain compensation for the all images; (14) proceeding a multi-band blending; (15) combining the images to form the confocal microscopy image; and (16) end.

### BACKGROUND OF THE INVENTION

1. Field of the Invention

The present invention generally relates to a method for composing a confocal microscopy image with a higher resolution, more particularly to a method that can achieve seamless image stitching for eliminating obvious visual artifacts caused by severe intensity discrepancy, image distortion and structure misalignment by pyramidal correlation, intensity adjustment, dynamic programming, SIFT, multi-band blending.

2. Description of the Prior Art

To understand the structure and functions of the human brains' neural networks is important but difficult due to its huge number of neuropils and complex functions. To simplify this problem, in the research of life science, fruit flies are chosen because of the number of cells and neuropils in a fruit fly's brain are much fewer and it is easier to get large number of their samples.

The first step of research is to combine a lot of data images. For higher-resolution pictures, confocal microscopy images of fluorescent dyeing fruit flies brains are taken, whose slice images consist of two or four or six overlapping parts at x-y plane and one stacking part at z-coordinate. An image stack might be composed of hundreds of slices, all numbered by z-coordinate, and because of tiny inaccuracy, the same sequence number of picture in different stacks might not present exactly the same z-coordinate. Another problem of fluorescent images is that fluorescence might be decayed by time within a shot. This makes intensity compensation of pictures difficult. In this invention, we try a few methods to solve these problems and obtain acceptable results.

To figure out the disadvantages may be an important issue to the persons skilled in the arts in order to develop a method for composing a confocal microscopy image with a higher resolution.

### SUMMARY OF THE INVENTION

The primary objective of the present invention is to provide a method for composing a confocal microscopy image with a higher resolution in order to achieve seamless image stitching for eliminating obvious visual artifacts caused by severe intensity discrepancy, image distortion and structure misalignment, given that the input images are globally registered. This approach is based on structure deformation and propagation while maintaining the overall appearance affinity of the result to the input images. This new approach is proven to be effective in solving the above problems, and has found applications in mosaic deghosting, image blending and intensity correction.

The aim of a stitching algorithm is to produce a visually plausible mosaic with two desirable properties. First, the mosaic should be as similar as possible to the input images, both geometrically and photometrically. Second, the seam between the stitched images should be invisible. While these requirements are widely acceptable for visual examination of a stitching result, their definition as quality criteria was either limited or implicit in previous approaches.

The method for composing a confocal microscopy image with a higher resolution comprising the steps of: (1) start; (2) to decide whether the number of images to be stitched are more than two, if no, going to step (3), otherwise, going to step (7); (3) proceeding pyramidal correlations; (4) gaining compensation for the overlapped region of the two images; (5) proceeding an intensity adjustment beyond the overlapped regions; (6) proceeding a dynamic programming, then going to step (15); (7) to decide whether the pyramidal correlation is a must, if yes, going to step (8), otherwise, going to step (12); (8) proceeding the pyramidal correlations; (9) proceeding an adjacency adjustment; (10) to decide whether a linear adjustment by a distance map is a must, if yes, going to step (11), otherwise, going to step (13); (11) proceeding the linear adjustment by the distance map; (12) proceeding an scale invariant feature transform (SIFT); (13) gaining compensation for the all images; (14) proceeding a multi-band blending; (15) combining the images to form the confocal microscopy image; and (16) end.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objectives, spirits, and advantages of the preferred embodiments of the present invention will be readily understood by the accompanying drawings and detailed descriptions, wherein:

FIG. 1 illustrates a flow chart of a method for composing a confocal microscopy image with a higher resolution of the present invention;

FIG. 2 illustrates a schematic view of a minimum error boundary cut using dynamic programming;

FIG. 3 illustrates a schematic view of down-sampled images arranged in order;

FIG. 4 illustrates a schematic view of correlation computation pixel by pixel;

FIG. 5A and FIG. 5B illustrates a schematic view of two correlation conditions, wherein FIG. 5A is that of correlated one but wrong match and FIG. 5B is a nice match;

FIG. 6 illustrates a schematic view of a search range of a next level (dashed line);

FIG. 7 illustrates a schematic view of a search method;

FIG. 8A and FIG. 8B illustrate a schematic view of ideal relationship between stacks and a schematic view of relationships between stacks in the experiment;

FIG. 9 illustrates a schematic view of a plurality of stages of image registration;

FIG. 10A and FIG. 10B illustrate a schematic view of two adjacent regions and a schematic view of a distance map of the two adjacent regions;

FIG. 11 illustrates a schematic view of sequential stages of combining two images;

FIG. 12A and FIG. 12B illustrate a view of six input microscopy images and a result view of applying SIFT on the six input microscopy images;

FIG. 13 illustrates a result view of a process of applying dynamic programming;

FIG. 14A and FIG. 14B illustrate a view of two input microscopy images and a result view of a combination of applying Equation (1-7) on the two input microscopy images;

FIG. 15A and FIG. 15B illustrate a view of two input microscopy images and a result view of a combination of applying Equation (1-6) on the two input microscopy images;

FIG. 16A and FIG. 16B illustrate a view of six input microscopy images and a result view of a combination of applying linear adjustment by distance map on the six input microscopy images;

FIG. 17A and FIG. 17B illustrate a view of six input microscopy images and a result view of a combination of applying linear adjustment by distance map on the six input microscopy images;

FIG. 18A, FIG. 18B and FIG. 18C illustrate a view of six input microscopy images, a view of the six input microscopy images after gain compensation and a result view of a combination of applying multi-band blending on the six input microscopy images.

### DETAILED DESCRIPTION OF THE INVENTION

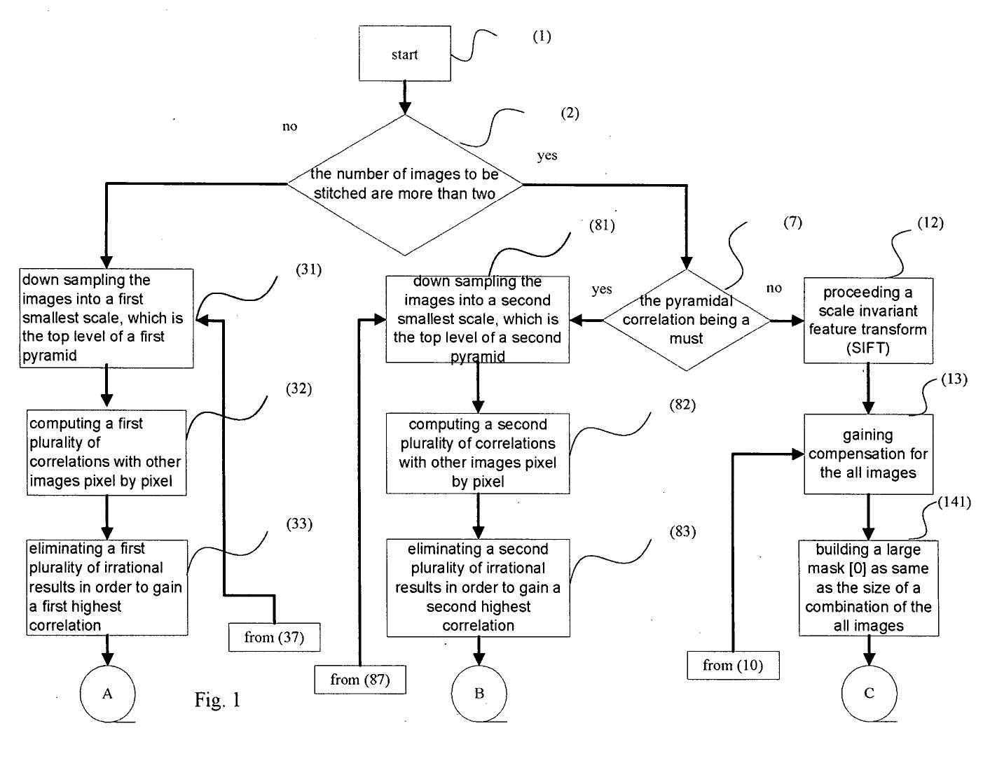

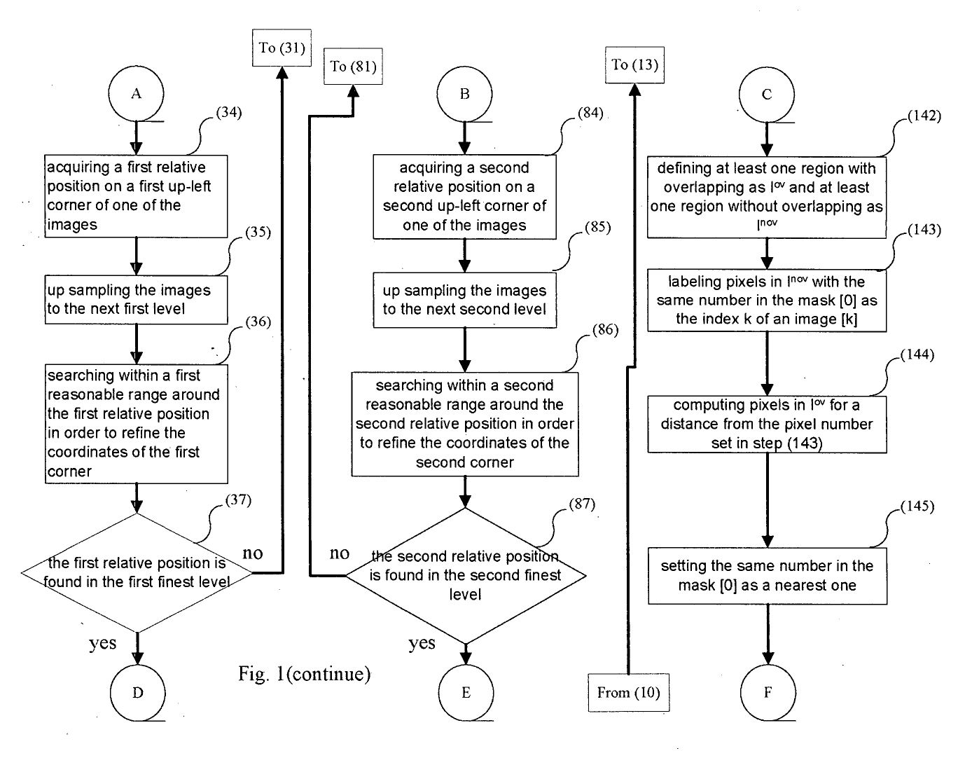

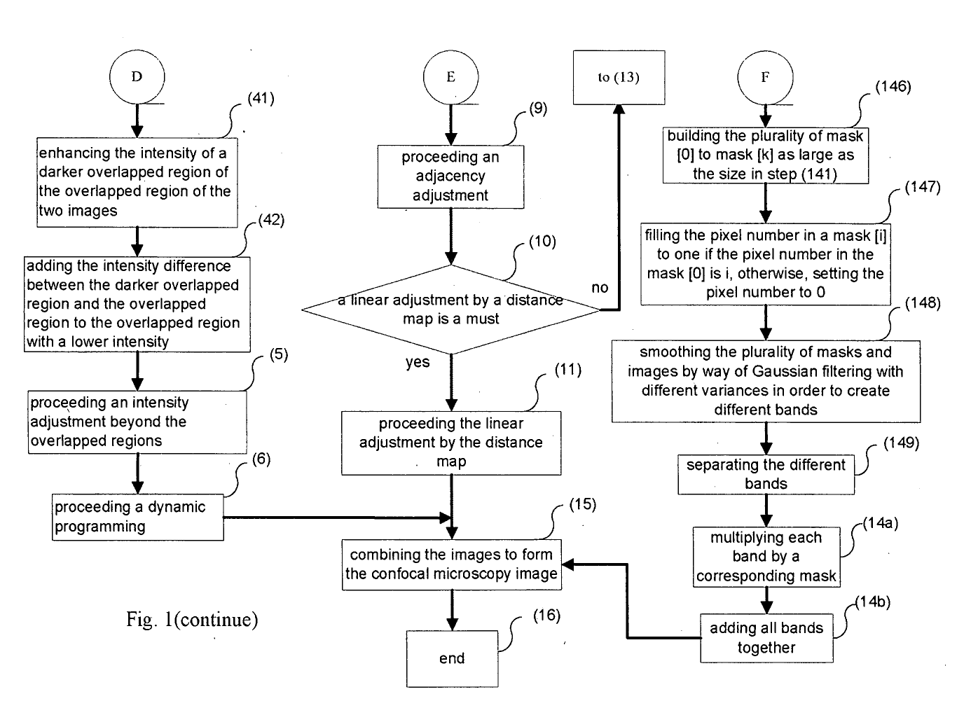

With reference to FIG. 1, which illustrates a flow chart of a method for composing a confocal microscopy image with a higher resolution of the present invention. The method includes the steps of:
(1) start;
(2) to decide whether the number of images to be stitched are more than two, if no, going to step (31), otherwise, going to step (7);
(31) down-sampling the images into a first smallest scale, which is the top level of a first pyramid;
(32) computing a first plurality of correlations with other images pixel by pixel;
(33) eliminating a first plurality of irrational results in order to gain a first highest correlation;
(34) acquiring a first relative position on a first upper-left corner of one of the images;
(35) up-sampling the images to the next first level;
(36) searching within a first reasonable range around the first relative position in order to refine the coordinates of the first corner;
(37) to determine whether the first relative position is found in the first finest level, if yes, going to step (41), otherwise, going to step (31);
(41) enhancing the intensity of a darker overlapped region of the overlapped region of the two images;
(42) adding the intensity difference between the darker overlapped region and the overlapped region to the overlapped region with a lower intensity;
(5) proceeding an intensity adjustment beyond the overlapped regions;
(6) proceeding a dynamic programming, then going to step (15);
(7) to decide whether the pyramidal correlation is a must, if yes, going step (81), otherwise, going to step (12);
(81) down-sampling the images into a second smallest scale, which is the top level of a second pyramid;
(82) computing a second plurality of correlations with other images pixel by pixel;
(83) eliminating a second plurality of irrational results in order to gain a second highest correlation;
(84) acquiring a second relative position on a second upper-left corner of one of the images;
(85) up-sampling the images to the next second level;
(86) searching within a second reasonable range around the second relative position in order to refine the coordinates of the second corner; and
(87) to determine whether the second relative position is found in the second finest level, if yes, going to step (9), otherwise, going to step (81);
(9) proceeding an adjacency adjustment;
(10) to decide whether a linear adjustment by a distance map is a must, if yes, going to step (11), otherwise, going to step (13);
(11) proceeding the linear adjustment by the distance map;
(12) proceeding a scale invariant feature transform (SIFT);
(13) gain compensation for the all images;
(141) building a large mask [0] as same as the size of a combination of all images;
(142) defining at least one region with overlapping as l^{ov} and at least one region without overlapping as l^{nov};
(143) labeling pixels in l^{nov} with the same number in the mask [0] as the index k of an image [k];
(144) computing pixels in l^{ov} for a distance from the pixel number set in step (143);
(145) setting the same number in the mask [0] as a nearest one;
(146) building the plurality of mask [0] to mask [k] as large as the size in step (141);
(147) filling the pixel number in a mask [i] to one if the pixel number in the mask [0] is i, otherwise, setting the pixel number to 0;
(148) smoothing the plurality of masks and images by way of Gaussian filtering with different variances in order to create different bands;
(149) separating the different bands;
(14a) multiplying each band by a corresponding mask;
(14b) adding all bands together;
(15) combining the images to form the confocal microscopy image; and
(16) end.

For step (6), which is related the dynamic programming and an algorithm design method that can be used when the solution to a problem may be viewed as the result of a sequence of decisions. It is a very robust technique for searching optimal alignments between various types of patterns because it is able to include order and continuity constraints during the search. However, it is applicable only for the search of mono-dimensional alignments (the reason is that no natural order can be found for a multidimensional set) and uneasy to use directly for image matching although some attempts have been made. The word “programming” in “dynamic programming” has no particular connection to computer programming at all, and instead comes from the term “mathematical programming”, a synonym for optimization. Thus, the “program” is the optimal plan for action that is produced. The dynamic programming is a method of solving problems exhibiting the properties of overlapping sub-problems and optimal substructure (described below) that takes much less time than naive methods. The dynamic programming usually takes two approaches listed below:

Top-down approach: The problem is broken into sub-problems, and these sub-problems are solved and the solutions remembered, in case they need to be solved again. This is recursion and memorization combined together.

Bottom-up approach: All sub-problems that might be needed are solved in advance and then used to build up solutions to larger problems. This approach is slightly better in stack space and number of function calls, but it is sometimes not intuitive to figure out all the sub-problems needed for solving the given problem.

The dynamic programming is originally used in texture synthesis, reducing blackness of the boundary between blocks. It is computed as a minimum cost path through the error surface at the overlap. We want to make the cut between two overlapping blocks on the pixels where the two textures match best. That is, the overlap error is the lowest. This can easily be done with the dynamic programming. Dijkstra's algorithm can be used as well.

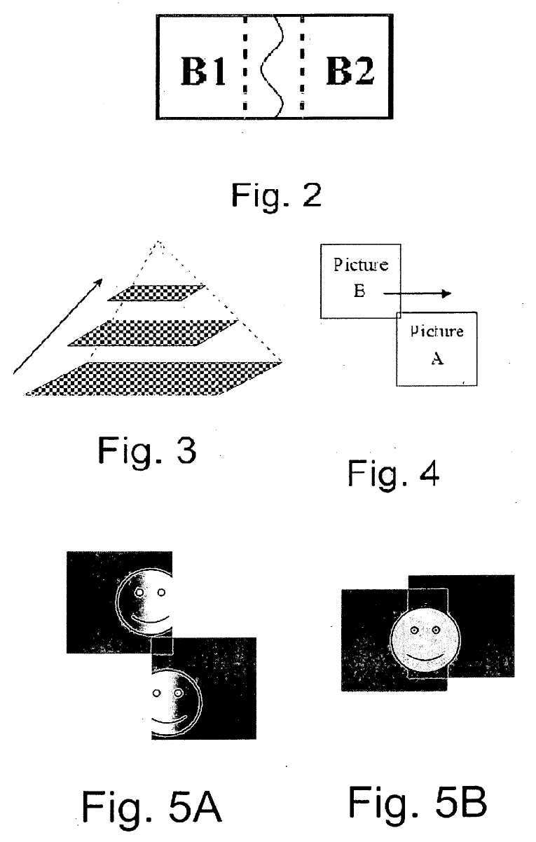

The minimal cost path through the error surface is computed in the following manner. With reference to FIG. 2, which illustrates a schematic view of a minimum error boundary cut using dynamic programming. If B1 and B2 are two blocks that overlap along their vertical edge with the regions of overlap B₁^{ov} and B₂^{ov}, respectively, then the error surface is defined as e=(B₁^{ov}−B₂^{ov}). To find the minimal vertical cut through this surface we traverse e(i=2 N) and compute the cumulative minimum error E for all paths:

E_{i,j}=e_{i,j}+min(E_{i-1,j-1},E_{i-1,j},E_{i-1,j+1}) (1-1)

In the end, the minimum value of the last row in E will indicate the end of the minimal vertical path though the surface and one can trace back and find the path of the best cut. Similar procedure can be applied to horizontal overlaps. When there are both vertical and horizontal overlaps, the minimal paths meet in the middle and the overall minimum is chosen for the cut.

In our experiment, we choose to use the dynamic programming at the beginning while the number of pictures is two. We treat two images as two huge blocks and try to find the shortest path of the overlap of the two images. It did a great work for combing two pictures and with a little modification with intensities, we could obtain satisfactory results.

But by the growing number of pictures to be stitched, dynamic programming is no more applicable because of the shapes of overlaps could be various. In other words, in the case of combing more than two images, we do not use the dynamic programming to eliminate seam.

Correlation provides one of the most common and most useful statistics. Correlation computation yields a single number that describes the degree of matching relationship between two random variables. Though it is a simple method, it produces good outcomes for the present invention.

For two random variables X and Y, their data pairs are (xᵢ, yᵢ), i=1, 2, . . . , n. Its mean and variance are x̅ and s_{X}, y and s_{Y}, respectively. Then correlation r is determined as

$$r = \frac{1}{n - 1} {\sum }_{i = 1}^{n} ( \frac{{x}_{i} - \overline{x}}{{s}_{X}} ) ( \frac{{y}_{i} - \overline{y}}{{s}_{Y}} ) \qquad ( 1 \text{-} 2 )$$

For the preferred embodiment, we consider six variables (stand for six pictures) at a time; we will get a data matrix which is correlation matrix. Because more pictures are to be computed to form a correlation matrix for further analysis, to shorten time, pyramidal correlation is used.

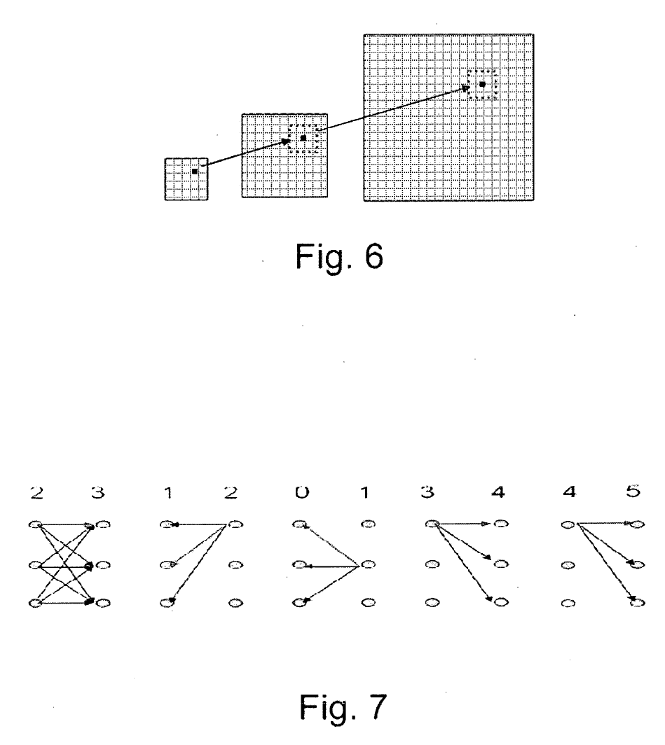

First of all, down-sampling images into the smallest scale, referring to FIG. 3, which illustrates a schematic view of down-sampled images arranged in order. By computing correlations with other pictures pixel by pixel, referring to FIG. 4, which illustrates a schematic view of correlation computation pixel by pixel, where dotted lines mark the search range of B, and eliminating irrational results, we add a threshold on variance s_{X} and s_{Y}, this is because the images all have background of zero intensity and if overlapping regions are all zero pixels and make correlation one, referring to FIG. 5A and FIG. 5B, which illustrates a schematic view of two correlation conditions, wherein FIG. 5A is that of correlation one but wrong match and FIG. 5B is a nice match. We could get the highest correlation and know the relative position lies on the upper-left corner. Then we up-sample images to the next level, and search within a reasonable range around the new position to refine the coordinates of the corner we've gotten before FIG. 6, which illustrates a schematic view of a search range of a next level (dashed line). Repeat the procedure until the position of overlapping is found in the finest level.

The diagonal of a correlation matrix (i.e., the numbers that go from the upper-left corner to the lower right) always consists of ones. That's because these are the correlations between each variable and itself (and a variable is always perfectly correlated with itself). And in our case, we only need correlation between different pictures, so we can skip these operations.

Otherwise, this program only computes the upper triangle of the correlation matrix. In every correlation matrix there are two triangular parts that lie below and to the left of the diagonal (lower triangle) and above and to the right of the diagonal (upper triangle). The two triangles of a correlation matrix are always mirror images of each other (the correlation of variable x with variable y is always equal to the correlation of variable y with variable x).

TABLE 1
Correlation matrix (one of the experimental results)

| | Img[0] | Img[1] | Img[2] | Img[3] | Img[4] | Img[5] |
|---|---|---|---|---|---|---|
| Img[0] | | 0.930926 | 0.869357 | 0.463536 | 0.456217 | 0.898263 |
| Img[1] | | | 0.93184 | 0.576419 | 0.429544 | 0.581173 |
| Img[2] | | | | 0.949069 | 0.536115 | 0.534995 |
| Img[3] | | | | | 0.917143 | 0.837898 |
| Img[4] | | | | | | 0.913916 |
| Img[5] | | | | | | |

Highest correlation being first found after searching the entire correlation matrix (Table 1), then we can decide the first image pair which is the pair <lmg[2], lmg[3]> as shown in Table 1. For continuity of pictures, we will search for the pair of the second highest correlation in the correlation matrix which has relations with the pictures in the image pair we already found. Continue the procedures until all pictures numbered (0˜5) have appeared in the image pair list (Table 2. (a)). Each image pair represents not only two images are adjacent, but also the relative positions of the pictures. During the process, all positions of images where they should be located in a combined image were decided (Table 2. (b)).

TABLE 2
(a) Image pair list (b) x-y coordinates of each picture
(result of Table 1.)

| | |
|---|---|
| (a) | (b) |

| | | | | |
|---|---|---|---|---|
| 1^{st} | Img[2] | Img[3] | Img[0] | (10, 0) |
| 2^{nd} | Img[1] | Img[2] | Img[1] | (4, 798) |
| 3^{rd} | Img[0] | Img[1] | Img[2] | (0, 1253) |
| 4^{th} | Img[3] | Img[4] | Img[3] | (730, 1259) |
| 5^{th} | Img[4] | Img[5] | Img[4] | (739, 789) |
| | | | Img[5] | (740, 26) |

For the preferred embodiment, we compute six slices with all the same sequence number in six stacks and assume that they are all at the same z-coordinate. But one stack of confocal microscopy images might have a little inaccuracy with another at z-coordinate. Because of the situation, we try to find the images which lie on the same plane really.

To solve the problem, we define a weight C which is the average of all correlations in the list of image pairs. We see C as a parameter which can tell us how much the combination is likely to be on the same plane. By substituting adjacent pictures to have new combination, we can determine which one might be close to the desired set of six images on the same plane.

$$C = \frac{{\sum }_{all pairs in a image pair list} correlation of image pair}{number of image pairs} \qquad ( 1 \text{-} 3 )$$

TABLE 3
Image pair list

| | | |
|---|---|---|
| 1^{st} | Img[2] | Img[3] |
| 2^{nd} | Img[1] | Img[2] |
| 3^{rd} | Img[0] | Img[1] |
| 4^{th} | Img[3] | Img[4] |
| 5^{th} | Img[4] | Img[5] |

But computing for six images and all the substitution cases (suppose the inaccuracy won't be over one adjacent slice), we might need to deal with 3⁶ (Take combing six pictures in (Table 1) for example) combinations to get the final answer. To reduce the computation, here is a method used. Due to the search method of the image pair operated before, all the picture pairs have continuity. So we can use the advantage of the continuity to start computing which combination is the desired result.

First, we compute an image pair with substituting n−1, n, n+1 slice, and this process will need 9 computations. And then the best pair will be selected to do the next step, compute the correlation of the image pair and substitute only the undetermined slice. After 3 computations, pick the best pair and repeat the action until all six pictures are determined.

With reference to Table 3 and FIG. 7, which illustrate a table for an image pair list and a schematic view of a search method. The numbers on the top is the index k of lmg[k]. Three rows of nodes from top to down stand for slice n−1, n, n+1 in different stacks. Red arrows mean the highest correlation selected in the stage been. Black arrows mean all the computation needed.

Due to the similarity of the combination between all pictures in six stacks, we can take advantage of the result. We chose about three consequent slices (more decisive ones) in each stack, and then through the procedure we can get the connections between slices of stacks. If six pictures are all of the same sequence number in the result of the program, it supposes the inaccuracy is less than one slice and we will use the relative positions of six pictures numbered the same in different stacks to combine all subsequent pictures in six stacks. Otherwise, we will take the difference of the slices and the relative positions between them into consideration to combine all subsequent slices in six stacks.

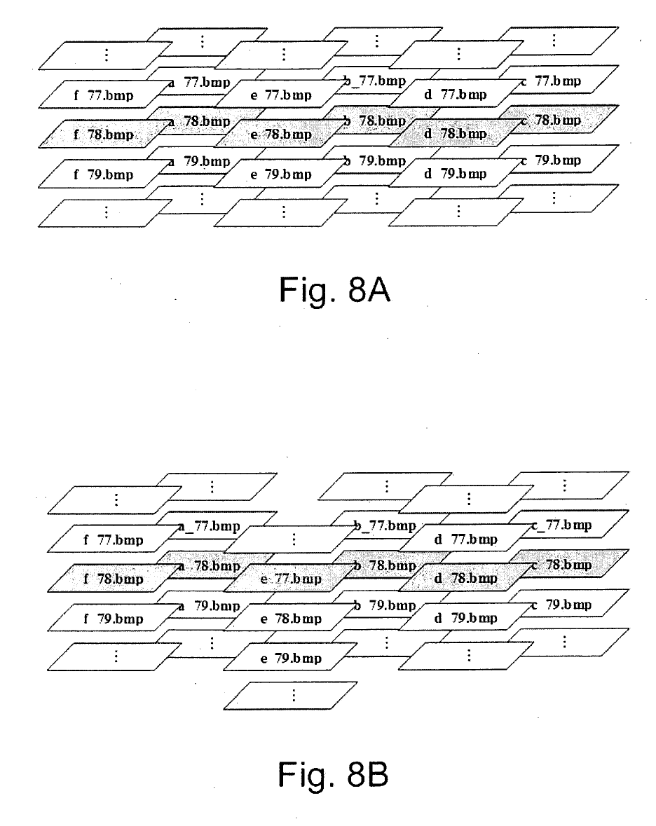

With reference to FIG. 8A and FIG. 8B, which illustrate a schematic view of ideal relationship between stacks and a schematic view of relationships between stacks in the experiment. For example, if we know that among the six stacks of slices the fifth needs to shift one slice downward to combine with the other stacks of slices to produce the best result of image blending. We will memorize the relative position of one of the combined results and shift every slice of the fifth stack in subsequent image-blending procedure. That will save a lot of time to re-compute the correlation of each pair of images for registration by taking the advantage of similar relationships among the stacks.

Back to step (12), which is that of proceeding a scale invariant feature transform, and it will be described below. SIFT (David G. Lowe, 2004), a condensation of Scale Invariant Feature Transform, as it transforms image data into scale-invariant coordinates relative to local features, is a novel and powerful algorithm to solve image matching problems. The major stages of computation used to generate the set of image features are as follows:

1. Scale-space extrema detection: The first stage of computation searches over all scales and image locations. It is implemented efficiently by using a difference-of-Gaussian function to identify potential interest points that are invariant to scale and orientation.
2. Keypoint localization: At each candidate location, a detailed model is fitted to determine location and scale. Keypoints are selected based on measures of their stability.
3. Orientation assignment: One or more orientations are assigned to each keypoint location based on local image gradient directions. All future operations are performed on image data that has been transformed relative to the assigned orientation, scale, and location for each feature, therefore providing invariance to these transformations.
4. Keypoint descriptor: The local image gradients are measured at the selected scale in the region around each keypoint. These are transformed into a representation that allows for significant levels of local shape distortion and change in illumination.

In David G. Lowe's another paper at 2007, Automatic Panoramic Image Stitching using Invariant Features, an excellent algorithm which is established on SIFT has been proposed to solve the problem of panorama stitching. It describes an invariant feature based approach to fully automatic panoramic image stitching. These invariant features enables reliable matching of panoramic image sequences despite rotation, zoom and illumination change in the input images. By viewing image stitching as a multi-image matching problem, it can automatically discover the matching relationships between the images, and recognize panoramas in unordered datasets. This algorithm has presented a novel system for fully automatic panorama stitching. The use of invariant local features and a probabilistic model to verify image matches allows us to recognize multiple panoramas in unordered image sets, and stitch them fully automatically without user input.

Although the automatic algorithm can solve a lot of image matching problems, but its parameters settings before running the program might be a considerable problem. In our experiment, by good settings of parameters, a few results are successfully combined through the Lowe's Algorithm and able to have wonderful effect.

According to step (31) to step (6) of FIG. 1, we consider about combing two images. After the image registration mentioned before, we obtain the relative positions of the images. Due to the attribute of the overlaps, we should adjust intensity of regions of overlap. And then dynamic programming would be used to eliminate the seam. Otherwise, intensity adjustment would be used in the regions beyond the overlaps. Because of the characteristic of the confocal microscopy images, the adjustment is usually applied on the darker regions of the overlaps.

After previous work, intensity adjustment is needed to apply to the images. Iₖ^{ov}(i,j) stands for regions of overlaps. In the case of two images combing, Īₖ^{ov} is the mean of Iₖ^{ov}(i,j), for k=1˜2

$${\overline{I}}_{k}^{ov} = \frac{{\sum }_{i = 1}^{m} {\sum }_{j = 1}^{n} {I}_{k}^{ov} ( i , j )}{m \times n} \qquad ( 1 \text{-} 4 )$$

If Ī₁^{ov}<Ī₂^{ov}, then we apply to region of overlap 1:

$${I}_{1}^{{ov}^{′}} ( i , j ) = {I}_{1}^{ov} ( i , j ) \times S , S = \frac{{\overline{I}}_{2}^{ov}}{{\overline{I}}_{1}^{ov}} \qquad ( 1 \text{-} 5 )$$

To enhance intensity of darker overlap is the first step of our work. Due to the double exposures of the region of fruit flies' brains, fluorescent regions of overlaps will attenuate more than the other regions beyond overlaps. The region exposed twice would be darker than the region exposed once. To deal with this situation, we tried to add the difference between them to the region of overlap with lower intensity. But the effect is not quite well, since the structure is a little bit destroyed. This operation would make structures not clear. After applying (1-5), the darker region of overlaps will be brighter but seem not to lose most of the structure.

The region beyond the overlaps would have characteristic mentioned below: regions near the overlaps would attenuate more than the regions far from the overlaps. So, we try several times to overcome the problem and try to make the loss of the original data as less as possible. We use a linear descending function decided by the distance of how far from the region of the overlap to apply functions to compensate the intensities. If x is distance of the pixel to the border to the overlap and D is the range of what we decided to compensate, then the ratio multiplied to the pixel is defined as m(x),

$$m ( x ) = S - ( \frac{S - 1}{D} ) \times x \qquad ( 1 \text{-} 6 )$$

Otherwise, we can choose other functions to substitute (1-6)

$$m ( x ) = ( S - 1 ) \times \frac{{exp}^{D - x}}{{exp}^{D}} + 1 \qquad ( 1 \text{-} 7 )$$

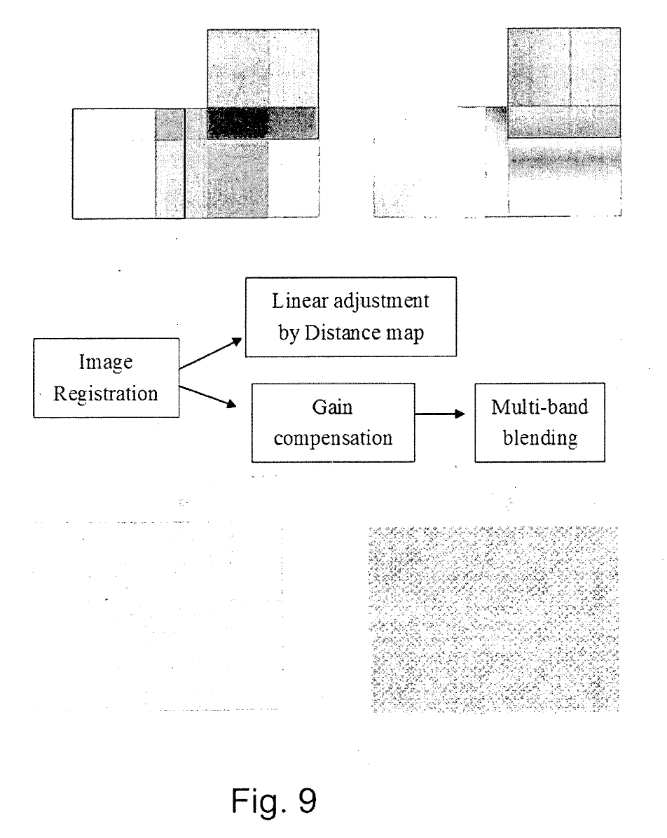

With reference to FIG. 9, which illustrates a schematic view of a plurality of stages of image registration. Therefore, for raising to higher resolution, fruit flies' brains have to be scanned into more parts. The shape and the attenuation of the regions of overlaps will be more complicated than the case of combing two images discussed before. On the other hand, images of fruit flies' brains scanned later need to raise the intensity manually because of the fluorescence attenuation, making the compensation of intensity harder. Therefore we could only try the best to make the combined image look like consistence, without much artificial impression.

Two methods have been used here. While combining the first two images, enhance the image which has lower average intensity by using distance map from the border of the overlap. In general case we will take the image with higher average intensity as the former scanned image, and the lower one as the later scanned image. So during the combining, encountering the regions of overlaps, we chose the overlap with higher average intensity to fill the blank. After combining theses two images, we see the resulting image as a new one, then re-compute the correlations between this one to the other images and choose the highest pair to do the combination. Repeat the procedure until there is only one picture remained. This method is quite intuitive and modifies only a part of intensities, under 10%, with acceptable results. Nonetheless it spends too much of time for re-computing large amount of correlations, and without adjusting average intensity of each image it would cause regional average intensity not equal. Each time, intensity change and then re-computing next correlation would possibly influence the result of registration.

To overcome the above-mentioned problem, we selected to compute the relative positions of the six images as discussed before. Then compute the average intensity of each image and all of the six images, revise each average intensity to the same level. At last we applied multi-band blending to make the results more acceptable.

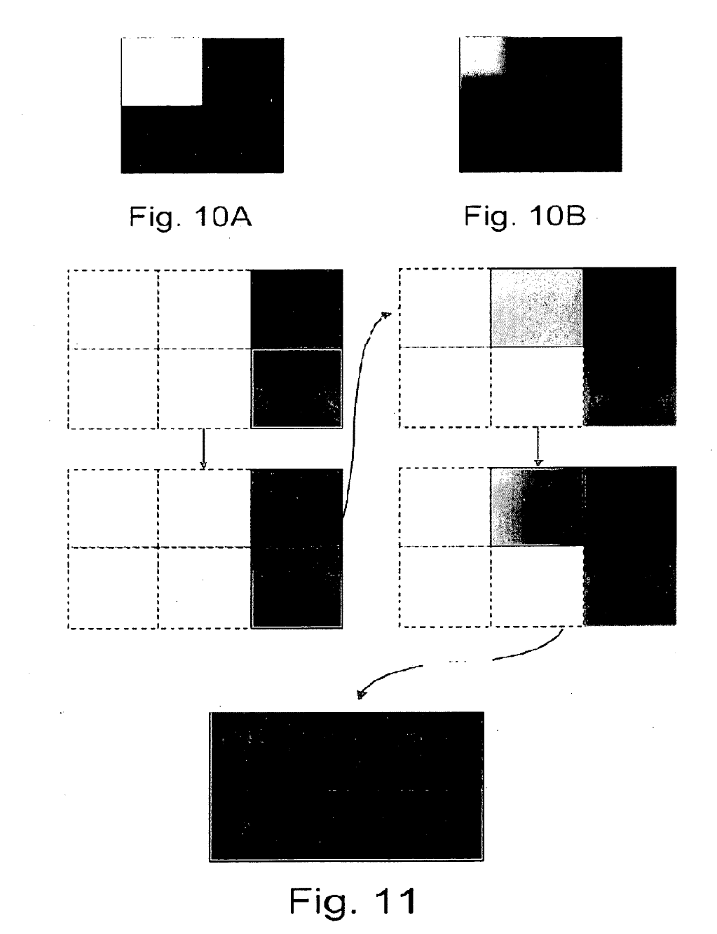

With reference to FIG. 10A, FIG. 10B and FIG. 11, which illustrate a schematic view of two adjacent regions, a schematic view of a distance map of the two adjacent regions and a schematic view of sequential stages of combining two images. After two images which have the highest correlation of the six ones have been found, the distance map will be calculated. In FIG. 10A, the black and white regions stand for the two images which are adjacency. FIG. 10B presents the distance map from the border between the two images. The distance map could be calculated by Euclidian Distance or for simplification, we set the first white pixel which is next to the black pixel as 1, and beside 1 we set it as 2, and so forth. Then as the pixel that numbered as 1, we multiplied its intensity a ratio S mentioned before. And as by use of Equation (1-6), we can make the intensity look smooth as the results. To modify the results better, we also add a parameter alpha to adjust the ratio S as S′=S*alpha. With or without alpha, linear compensation by using the distance map can yield good results.

For eliminating the difference of the images with their average intensities. The mean of each image is

$${\overline{I}}_{k} = \frac{{\sum }_{i = 1}^{m} {\sum }_{j = 1}^{n} {I}_{k} ( i , j )}{m \times n} k = 1 … 6 \qquad ( 1 \text{-} 8 )$$

And the mean of all input images can be computed by

$$\tilde{I} = \frac{{\sum }_{k = 1}^{6} {\sum }_{{i}_{k} = 1}^{{m}_{k}} {\sum }_{{j}_{k} = 1}^{{n}_{k}} {I}_{k} ( {i}_{k} , {j}_{k} )}{{\sum }_{k = 1}^{6} {m}_{k} \times {n}_{k}} \qquad ( 1 \text{-} 9 )$$

We adjust the intensity of each input image as

$${I}_{k}^{′} ( i , j ) = {I}_{k} ( i , j ) \times \frac{\tilde{I}}{{\overline{I}}_{k}} k = 1 … 6 \qquad ( 1 \text{-} 10 )$$

With several tries we choose not to ignore the background nor to consider the overlap as special cases because of two reasons: first, ignoring the background or considering the overlaps would not give a good result in these cases; second, with or without ignoring the background or considering the overlaps would not affect the ratio of compensation too much. Even the two ratios would not differ a lot, we choose Equations (1-7)˜(1-10) since we intend to have better results.

Back to step (141) to step (14b), which are the steps of multi-band blending. Ideally each sample (pixel) along a ray would have the same intensity in every image that it intersects, but in reality this is not the case. Even after gaining compensation some image seams are still visible. Because of this, a good blending strategy is important.

A simple approach to blending is to perform a weighted sum of the image intensities along each ray using weight functions. However, this approach can cause blurring of high frequency detail if there are small registration errors. To prevent this we use the multi-band blending algorithm of Burt and Adelson. The idea behind multi-band blending is to blend low frequencies over a large spatial range and high frequencies over a short range.

By applying these steps, the gradient of intensities is smoother and the seam between six images is not visible.

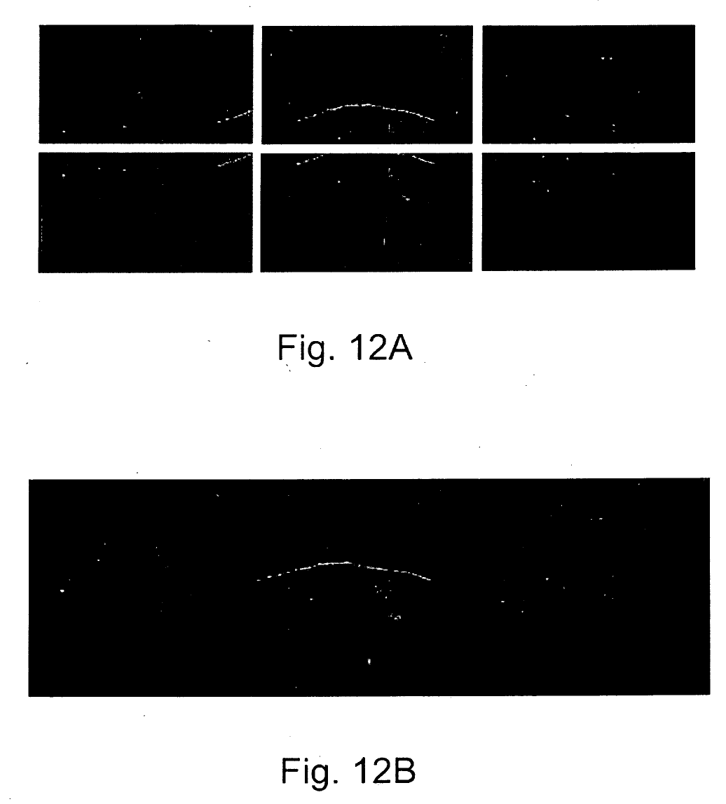

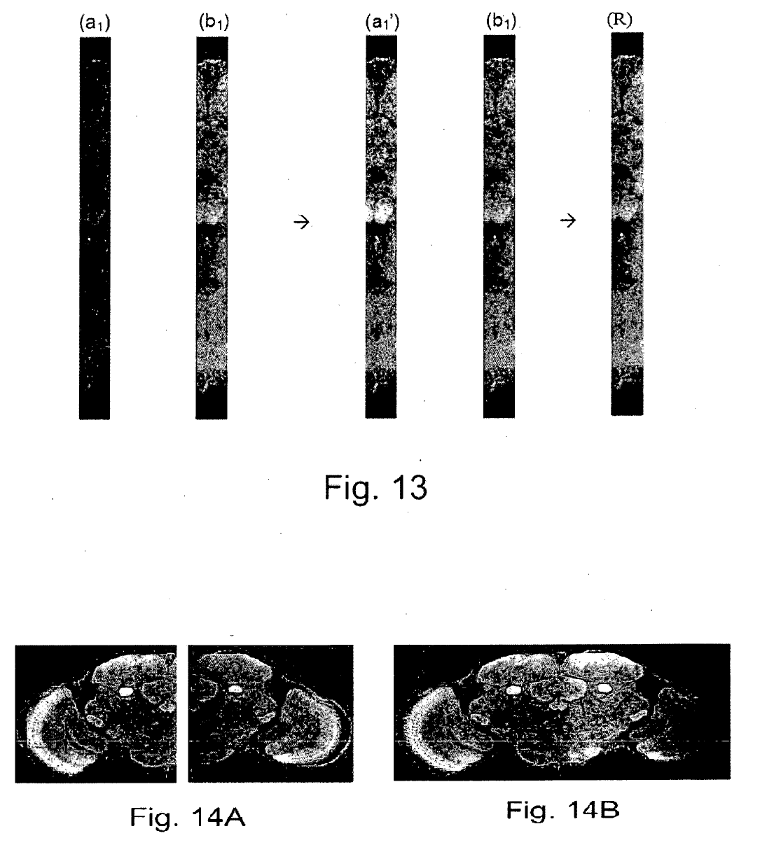

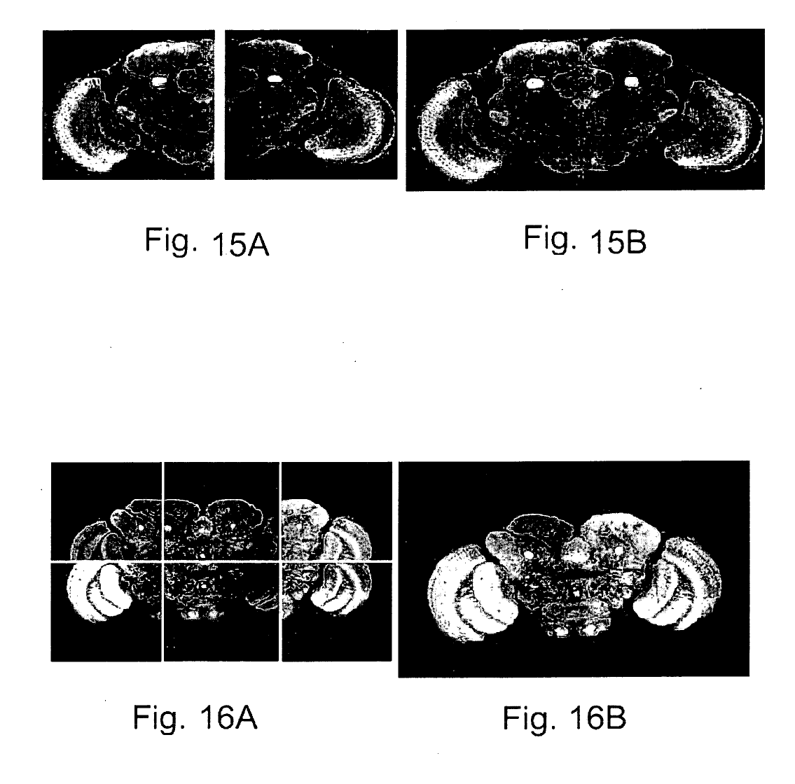

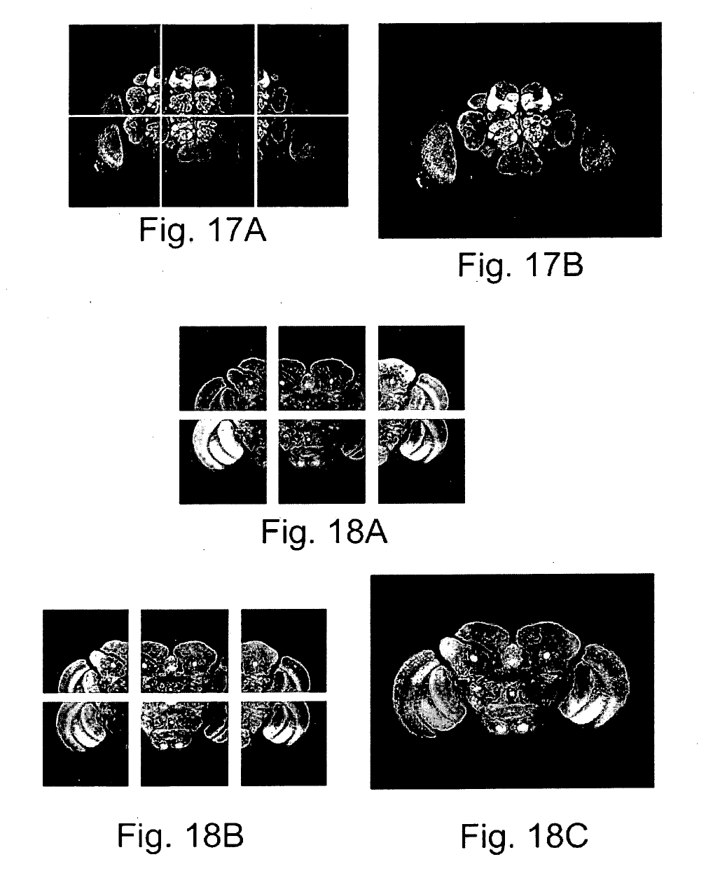

Following will be the results for SIFT, dynamic programming, combining two images, and combining a plurality of images. With reference to FIG. 12A and FIG. 12B, which illustrate a view of six input microscopy images and a result view of applying SIFT on the six input microscopy images. With reference to FIG. 13, which illustrates a result view of a process of applying dynamic programming, wherein bar a₁ is one of the regions of overlaps, bar b₁ is the other one of the regions of overlaps, bar a₁′ is bar a₁ after applying Equation (1-5), and bar R is the result of applying dynamic programming on bar a₁′ and b₁. Referring to FIG. 14A and FIG. 14B, which illustrate a view of two input microscopy images and a result view of a combination of applying Equation (1-7) on the two input microscopy images. Referring to FIG. 15A and FIG. 15B, which illustrate a view of two input microscopy images and a result view of a combination of applying Equation (1-6) on the two input microscopy images. Referring to FIG. 16A and FIG. 16B, which illustrate a view of six input microscopy images and a result view of a combination of applying linear adjustment by distance map on the six input microscopy images. Referring to FIG. 17A and FIG. 17B, which illustrate a view of six input microscopy images and a result view of a combination of applying linear adjustment by distance map on the six input microscopy images. Referring to FIG. 18A, FIG. 18B and FIG. 18C, which illustrate a view of six input microscopy images, a view of the six input microscopy images after gain compensation and a result view of a combination of applying multi-band blending on the six input microscopy images.

In the work of image registration by pyramidal correlation, we can find a good result for two images and also for multi-images. Then with adjacency adjustment, the result of combination image we found is more close to the same plane in the real world. And dynamic programming produces a good effect for eliminating the seam. Otherwise, SIFT is a powerful method in mosaic, but need more complicated parameter setting.

In the combination of two images, we take overlaps as most important parts of intensity decay. So all of our efforts are focused on the regions of overlaps and the regions near them, and we got acceptable results. But in the case of combination of multi-images, the monolithic appearance became more important. Therefore we tried different methods to complete adjustments such as linear adjustment by distance map, gain compensation and multi-band blending. Multi-band blending method keeps more high-frequency details of the images.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for composing a confocal microscopy image with a higher resolution comprising the steps of:
(1) start;
(2) to decide whether the number of images to be stitched are more than two, if no, going to step (3), otherwise, going to step (7);
(3) proceeding pyramidal correlations;
(4) gaining compensation for the overlapped region of the two images;
(5) proceeding an intensity adjustment beyond the overlapped regions;
(6) proceeding a dynamic programming, then going to step (15);
(7) to decide whether the pyramidal correlation is a must, if yes, going step
(8), otherwise, going to step (12);
(8) proceeding the pyramidal correlations;
(9) proceeding an adjacency adjustment;
(10) to decide whether a linear adjustment by a distance map is a must, if yes, going to step (11), otherwise, going to step (13);
(11) proceeding the linear adjustment by the distance map;
(12) proceeding an scale invariant feature transform (SIFT);
(13) gain compensation for the all images;
(14) proceeding a multi-band blending;
(15) combining the images to form the confocal microscopy image; and
(16) end.

2. The method for composing the confocal microscopy image with the higher resolution according to claim 1, wherein step (3) further comprises the steps of:
(31) down-sampling the images into a first smallest scale, which is the top level of a first pyramid;
(32) computing a first plurality of correlations with other images pixel by pixel;
(33) eliminating a first plurality of irrational results in order to gain a first highest correlation;
(34) acquiring a first relative position on a first upper-left corner of one of the images;
(35) up-sampling the images to the next first level;
(36) searching within a first reasonable range around the first relative position in order to refine the coordinates of the first corner; and
(37) to determine whether the first relative position is found in the first finest level, if yes, going to step (4), otherwise, going to step (31).

3. The method for composing the confocal microscopy image with the higher resolution according to claim 1, wherein step (4) further comprises the steps of:
(41) enhancing the intensity of a darker overlapped region of the overlapped region of the two images; and
(42) adding the intensity difference between the darker overlapped region and the overlapped region to the overlapped region with lower intensity.

4. The method for composing the confocal microscopy image with the higher resolution according to claim 1, wherein step (8) further comprises the steps of:
(81) down-sampling the images into a second smallest scale, which is the top level of a second pyramid;
(82) computing a second plurality of correlations with other images pixel by pixel;
(83) eliminating a second plurality of irrational results in order to gain a second highest correlation;
(84) acquiring a second relative position on a second up-left corner of one of the images;
(85) up-sampling the images to the next second level;
(86) searching within a second reasonable range around the second relative position in order to refine the coordinates of the second corner; and
(87) to determine whether the second relative position is found in the second finest level, if yes, going to step (9), otherwise, going to step (81).

5. The method for composing the confocal microscopy image with the higher resolution according to claim 1, wherein step (14) further comprises the steps of:
(141) building a large mask [0] as same as the size of a combination of the all images;
(142) defining at least one region with overlapping as l^{ov} and at least one region without overlapping as l^{nov};
(143) labeling pixels in l^{nov} with the same number in the mask [0] as the index k of an image [k];
(144) computing pixels in l^{ov} for a distance from the pixel number set in step
(143);
(145) setting the same number in the mask [0] as a nearest one;
(146) building the plurality of mask [0] to mask [k] as large as the size in step (141);
(147) filling the pixel number in a mask [i] to one if the pixel number in the mask [0] is i, otherwise, setting the pixel number to 0;
(148) smoothing the plurality of masks and images by way of Gaussian filtering with different variances in order to create different bands;
(149) separating the different bands;
(14a) multiplying each band by a corresponding mask; and
(14b) adding all bands together.
